(19) United States
(12) Patent Application Publication
(10) Pub. No.: US 2024/0291204 A1
(43) Pub. Date: Aug. 29, 2024

(54) CONNECTOR

(71) Applicant: SUMITOMO WIRING SYSTEMS, LTD., Mie (JP)

(72) Inventor: Masanori HIROTA, Mie (JP)

(21) Appl. No.: 18/443,783

(22) Filed: Feb. 16, 2024

(30) Foreign Application Priority Data
Feb. 28, 2023 (JP) 2023-029218

(51) Int. Cl. H01R 13/639; H01R 13/514; H01R 13/629

(52) U.S. Cl. CPC H01R 13/639; H01R 13/514; H01R 13/62955

(57) ABSTRACT

A lever-type connector to be connected to a male connector is provided with a connector body and a wire cover. A first lock portion includes a first lock piece extending downward (forward in a connection direction) from the wire cover and having a cover-side first engaging projection protruding leftward (toward one side in a first direction orthogonal to the connection direction), and a first lock receiving portion provided on a left side (one side) of the first lock piece in the connector body and including a body-side first engaging projection protruding rightward (toward the other side in the first direction) and to be engaged with the cover-side first engaging projection. A wall for suppressing the disengagement of the cover-side first engaging projection from the body-side first engaging projection is provided on a right side of the first lock piece.

### CROSS-REFERENCE TO RELATED APPLICATIONS

This application is based on and claims priority from Japanese Patent Application No. 2023-029218, filed on Feb. 28, 2023, with the Japan Patent Office, the disclosure of which is incorporated herein in its entirety by reference.

### TECHNICAL FIELD

The present disclosure relates to a connector.

### BACKGROUND

Conventionally, there is known a connector provided with a connector body having a wire pulled out from a rear side in a connection direction, a box-shaped wire cover locked to the rear side in the connection direction of the connector body, one side of the wire cover in a first direction orthogonal to the connection direction being open, the wire pulled out from the connector body being bent toward the one side inside the wire cover and pulled out from the wire cover, and a lock portion for locking the connector body and the wire cover (see, for example, Japanese Patent Laid-open Publication Nos. 2003-272768 and 2018-106801).

A cover-equipped connector described in Japanese Patent Laid-open Publication No. 2003-272768 is provided with a connector housing 10 (corresponding to the connector body) and a rear cover 30 (corresponding to the wire cover) as shown in FIG. 1 of Japanese Patent Laid-open Publication No. 2003-272768, and a linear body is pulled out from one side in a direction (first direction) orthogonal to a connection direction. The connector housing 10 is provided with locking portions 17 on both sides in a direction orthogonal to both the connection direction and the first direction. The rear cover 30 is provided with engaging portions 37 on both sides in the direction orthogonal to both the connection direction and the first direction. The rear cover 30 is locked to the connector housing 10 by locking the engaging portions 37 by the locking portions 17.

A connector assembly described in Japanese Patent Laid-open Publication No. 2018-106801 is provided with an outer housing 21 (corresponding to the connector body) and a cover 30 (corresponding to the wire cover) as shown in FIG. 2 of Japanese Patent Laid-open Publication No. 2018-106801, and a cable 5 is pulled out from one side in a direction (first direction) orthogonal to a connection direction. A locking hole 34 of the cover 30 and a locking portion 26b of the outer housing 21 are provided on the other side in the first direction. Further, locking holes 34 of the cover 30 and locking portions 26b of the outer housing 21 are provided also on both sides in a direction orthogonal to both the connection direction and the first direction, and the cover 30 is locked to the outer housing 21 by fitting the locking portions 26b into the locking holes 34.

### SUMMARY

However, conventionally, a problem when a wire cover, in which a wire pulled out from a connector body is bent toward one side in a first direction orthogonal to a connection direction inside the wire cover and from which the wire is pulled out, is mounted on a connector body has not been sufficiently studied.

In this specification, a technique is disclosed which enables a wire cover to be stably mounted even in the case of using a wire having a large diameter.

The present disclosure is directed to a connector to be connected to a mating connector, the connector being provided with a connector body, a wire being pulled out from a rear side in a connection direction, a box-shaped wire cover disposed on the rear side in the connection direction of the connector body, one side of the wire cover in a first direction orthogonal to the connection direction being open, the wire pulled out from the connector body being bent toward the one side inside the wire cover and pulled out from the wire cover, a first lock portion for locking the connector body and the wire cover, the first lock portion being provided further on the other side in the first direction than the wire, and second lock portions for locking the connector body and the wire cover, the second lock portion being provided on each of both sides in a second direction orthogonal to both the connection direction and the first direction, the first lock portion including a first lock piece extending forward in the connection direction from the wire cover, the first lock piece including a cover-side first engaging projection protruding toward the one side, and a first lock receiving portion provided further on the one side than the first lock piece in the connector body, the first lock receiving portion including a body-side first engaging projection protruding toward the other side and to be engaged with the cover-side first engaging projection, and a wall for suppressing the cover-side first engaging projection from being disengaged from the body-side first engaging projection being provided further on the other side than the first lock piece.

According to the present disclosure, a wire cover can be stably mounted even in the case of using a wire having a large diameter.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a lever-type connector and a male connector according to a first embodiment.

FIG. 2 is a side view showing an initial connection position of a lever.

FIG. 3 is a side view showing a connection completion position of the lever.

FIG. 4 is a side view showing a transportation position of the lever.

FIG. 5 is a perspective view of a connector body.

FIG. 6 is a section of the lever-type connector (in a state where a wire cover is not completely mounted yet).

FIG. 7 is a perspective view of the wire cover when viewed from below.

FIG. 8 is a perspective view of the lever.

FIG. 9 is a top view of the connector body and the lever.

FIG. 10 is a section enlargedly showing a first lock portion.

FIG. 11 is a section of the lever-type connector (in a state where the wire cover is completely mounted).

FIG. 12 is a section of the lever-type connector.

FIG. 13 is a side view of the lever-type connector (in the state where the wire cover is completely mounted).

FIG. 14 is a section enlargedly showing a first lock portion according to a second embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.
(1) The connector of the present disclosure is to be connected to a mating connector and provided with a connector body, a wire being pulled out from a rear side in a connection direction, a box-shaped wire cover disposed on the rear side in the connection direction of the connector body, one side of the wire cover in a first direction orthogonal to the connection direction being open, the wire pulled out from the connector body being bent toward the one side inside the wire cover and pulled out from the wire cover, a first lock portion for locking the connector body and the wire cover, the first lock portion being provided further on the other side in the first direction than the wire, and second lock portions for locking the connector body and the wire cover, the second lock portion being provided on each of both sides in a second direction orthogonal to both the connection direction and the first direction, the first lock portion including a first lock piece extending forward in the connection direction from the wire cover, the first lock piece including a cover-side first engaging projection protruding toward the one side, and a first lock receiving portion provided further on the one side than the first lock piece in the connector body, the first lock receiving portion including a body-side first engaging projection protruding toward the other side and to be engaged with the cover-side first engaging projection, and a wall for suppressing the cover-side first engaging projection from being disengaged from the body-side first engaging projection being provided further on the other side than the first lock piece.

According to the connector described in (1) above, a worker first obliquely inserts the first lock piece into the connector body and engages the cover-side first engaging projection with the body-side first engaging projection when mounting the wire cover on the connector body. Then, the worker rotates the wire cover in a direction to lock the second lock portion with a contact point of the cover-side first engaging projection and the body-side first engaging projection as a fulcrum. In this way, the second lock portion can be locked while bending the wire toward the one side in the first direction by the wire cover. That is, according to the connector described in (1) above, the work efficiency of the worker is improved since an operation of bending the wire and an operation of locking the second lock portion can be performed as one operation.

However, there is a possibility that the cover-side first engaging projection is disengaged from the body-side first engaging projection toward the other side in the first direction when the wire cover is rotated with the above contact point as a fulcrum. Particularly, in the case of using a wire having a large diameter, the wire is hard to bend. Thus, the wire cover needs to be rotated with a strong force and there is a high possibility that the first lock piece is resiliently deformed and the cover-side first engaging projection is disengaged from the body-side first engaging projection.

According to the connector described in (1) above, since the wall for suppressing the disengagement of the cover-side first engaging projection from the body-side first engaging projection toward the other side is provided further on the other side in the first direction than the first lock piece, the cover-side first engaging projection is made less likely to be disengaged from the body-side first engaging projection by the contact of the first lock piece with the wall. Therefore, according to the connector described in (1) above, the wire cover can be stably mounted even in the case of using the wire having a large diameter.
(2) The connector of the present disclosure is to be connected to a mating connector and provided with a connector body, a wire being pulled out from a rear side in a connection direction, a box-shaped wire cover disposed on the rear side in the connection direction of the connector body, one side of the wire cover in a first direction orthogonal to the connection direction being open, the wire pulled out from the connector body being bent toward the one side inside the wire cover and pulled out from the wire cover, a first lock portion for locking the connector body and the wire cover, the first lock portion being provided further on the other side in the first direction than the wire, and second lock portions for locking the connector body and the wire cover, the second lock portion being provided on each of both sides in a second direction orthogonal to both the connection direction and the first direction, the first lock portion including a first lock piece extending forward in the connection direction from the wire cover, the first lock piece including a cover-side first engaging projection protruding toward the other side, and a first lock receiving portion provided further on the other side than the first lock piece in the connector body, the first lock receiving portion including a body-side first engaging projection protruding toward the one side and to be engaged with the cover-side first engaging projection, and a wall for suppressing the cover-side first engaging projection from being disengaged from the body-side first engaging projection being provided further on the one side than the first lock piece.

According to the connector described in (2) above, since the wall for suppressing the disengagement of the cover-side first engaging projection from the body-side first engaging projection toward the one side is provided further on the one side in the first direction than the first lock piece, the cover-side first engaging projection is made less likely to be disengaged from the body-side first engaging projection by the contact of the first lock piece with the wall. Therefore, according to the connector described in (2) above, the wire cover can be stably mounted even in the case of using the wire having a large diameter.
(3) The connector described in (1) or (2) above may be provided with a lever assembled with the connector body rotatably from an initial connection position to a connection completion position, the lever assisting connection of the connector body and the mating connector by a booster mechanism, and a temporary locking portion for temporarily locking the lever at a temporary locking position between the initial connection position and the connection completion position, and, when the lever is temporarily locked at the temporary locking position, at least a part of a position where the first lock piece is to be inserted in the connector body may not been seen by being hidden behind the lever when viewed from behind in the connection direction.

According to the connector described in (3) above, since the position where the first lock piece is to be inserted is not seen by being hidden behind the lever when the lever is temporarily locked at the temporary locking position, the worker can intuitively understand that the first lock piece needs to be obliquely inserted into the connector body. In other words, the worker can intuitively understand a method of mounting the wire cover by obliquely inserting the first lock piece into the connector body.
(4) In the connector described in (1) or (2) above, the second lock portion may include a second lock piece extending rearward in the connection direction from the connector body, the second lock piece including a body-side second engaging projection, and a second lock receiving portion provided on the wire cover, the second lock receiving portion including a cover-side second engaging projection to be engaged with the body-side second engaging projection, and the connector body may be provided with the first lock receiving portion on each of both sides in the first direction and the second lock piece on each of both sides in the second direction, and a plurality of the first lock receiving portions may be disposed point-symmetrically with respect to a center point of the connector body and a plurality of the second lock pieces may be disposed point-symmetrically with respect to the center point when viewed from behind in the connection direction.

A certain structure may be possibly present around the mating connector and the wire cannot be pulled out from the one side in the first direction and has to be pulled out from the other side in the first direction due to the presence of that structure. In this case, if two types of connectors, i.e. a connector from which the wire is pulled out from one side and a connector from which the wire is pulled out from the other side, have to be prepared, production cost increases due to an increase in the types of molds and the like and, in addition, management cost increases due to an increase in the type of the connectors.

According to the connector described in (4) above, since the plurality of first lock receiving portions are disposed point-symmetrically with respect to the center point of the connector body and the plurality of second lock pieces are disposed point-symmetrically with respect to the center point in the connector body when viewed from behind in the connection direction, the wire cover can be mounted on the connector body even if the wire cover is rotated by 180° about the center point of the connector body when viewed from behind in the connection direction. Thus, the wire can be selectively pulled out from the one side and the other side in the first direction, using one type of connector. In other words, the wire cover can be reversibly used. Therefore, production cost and management cost can be suppressed as compared to the case where two types of connectors are prepared.
(5) In the connector described in (4) above, the connector body may be provided with two second lock pieces on each of the both sides in the second direction and the two second lock pieces provided on the same side in the second direction may be provided on the one side and the other side with respect to a center in the first direction of the connector body, the wire cover may be provided with the second lock receiving portions at positions corresponding to the second lock pieces on the one side and formed with cuts for allowing the body-side second engaging projections to escape at positions corresponding to the second lock pieces on the other side, and a corner part on the one side, out of corner parts on a front side in the connection direction of the cut, may be chamfered to form a slope.

Unless the corner part on the one side, out of the corner parts on the front side in the connection direction of the cut, is chamfered, there is a possibility that the body-side second engaging projection contacts the corner part of the cut and the wire cover becomes hard to rotate when the wire cover is mounted by being rotated.

According to the connector described in (5) above, since the corner part on the one side, out of the corner parts on the front side in the connection direction of the cut, is chamfered, it can be suppressed that the body-side second engaging projection contacts the corner part of the cut and the wire cover becomes hard to rotate.
(6) In the connector described in (5) above, the second lock receiving portion may include a groove formed in an inner surface of the wire cover and extending in the connection direction, the body-side second engaging projection being inserted into the groove from front in the connection direction, the cover-side second engaging projection may be provided in the groove, and a corner on a front side in the connection direction and an inner side of the groove may be chamfered to form a slope.

Unless the above corner is chamfered, the body-side second engaging projection contacts the corner of the groove and cannot be inserted into the groove and the wire cover becomes hard to rotate when the wire cover is mounted by being rotated.

According to the connector described in (6) above, since the corner on the front side in the connection direction and the inner side of the groove is chamfered, it can be suppressed that the body-side second engaging projection contacts the corner of the groove and the wire cover becomes hard to rotate.
(7) In the connector described in (1) or (2) above, the second lock portion may include a second lock piece extending forward in the connection direction from the wire cover, the second lock piece including a cover-side second engaging projection, and a second lock receiving portion provided on the connector body, the second lock receiving portion including a body-side second engaging projection to be engaged with the cover-side second engaging projection, and the connector body may be provided with the first lock receiving portion on each of both sides in the first direction and the second lock receiving portion on each of both sides in the second direction, and a plurality of the first lock receiving portions may be disposed point-symmetrically with respect to a center point of the connector body and a plurality of the second lock receiving portions may be disposed point-symmetrically with respect to the center point when viewed from behind in the connection direction.

According to the connector described in (7) above, since the plurality of first lock receiving portions are disposed point-symmetrically with respect to the center point of the connector body and the plurality of second lock receiving portions are disposed point-symmetrically with respect to the center point in the connector body when viewed from behind in the connection direction, the wire cover can be mounted on the connector body even if the wire cover is rotated by 180° about the center point of the connector body when viewed from behind in the connection direction. Thus, the wire can be selectively pulled out from the one side and the other side in the first direction, using one type of connector. In other words, the wire cover can be reversibly used. Therefore, production cost and management cost can be suppressed as compared to the case where two types of connectors are prepared.
(8) In the connector described in (7) above, the wire cover may be provided with two second lock pieces on each of both sides in the second direction and the two second lock pieces provided on the same side in the second direction may be provided on the one side and the other side with respect to a center in the first direction of the connector body, the connector body may be provided with the second lock receiving portions at positions corresponding to the second lock pieces on the one side and formed with cuts for allowing the cover-side second engaging projections to escape at positions corresponding to the second lock pieces on the other side, and a corner part on the one side, out of corner parts on a rear side in the connection direction of the cut may be chamfered to form a slope.

According to the connector described in (8) above, since the corner part on the one side, out of the corner parts on the rear side in the connection direction of the cut, is chamfered, it can be suppressed that the cover-side second engaging projection contacts the corner part of the cut and the wire cover becomes hard to rotate.
(9) In the connector described in (8) above, the second lock receiving portion may include a groove formed in an inner surface of the connector body and extending in the connection direction, the cover-side second engaging projection being inserted into the groove from behind in the connection direction, the body-side second engaging projection may be provided in the groove, and a corner on a rear side in the connection direction and an inner side of the groove may be chamfered to form a slope.

Unless the above corner is chamfered, the cover-side second engaging projection contacts the corner of the groove and cannot be inserted into the groove and the wire cover becomes hard to rotate when the wire cover is mounted by being rotated.

According to the connector described in (9) above, since the corner on the rear side in the connection direction and the inner side of the groove is chamfered, it can be suppressed that the cover-side second engaging projection contacts the corner of the groove and the wire cover becomes hard to rotate.
(10) In the connector described in (1) or (2) above, a backlash eliminating rib may be formed on at least one of an end surface of the wire cover facing forward in the connection direction and a surface of the connector body facing the end surface.

According to the connector described in (10) above, the backlash of the wire cover and the connector body can be eliminated by the backlash eliminating rib. Further, since a gap is formed between the wire cover and the connector body due to the presence of the backlash eliminating rib, the wire cover mounted on the connector body can be removed by inserting a jig into this gap.

### Details of Embodiment of Present Disclosure

Hereinafter, embodiments of the present disclosure are described. The present disclosure is not limited to these illustrations, but is represented by claims and intended to include all changes in the scope of claims and in the meaning and scope of equivalents.

### First Embodiment

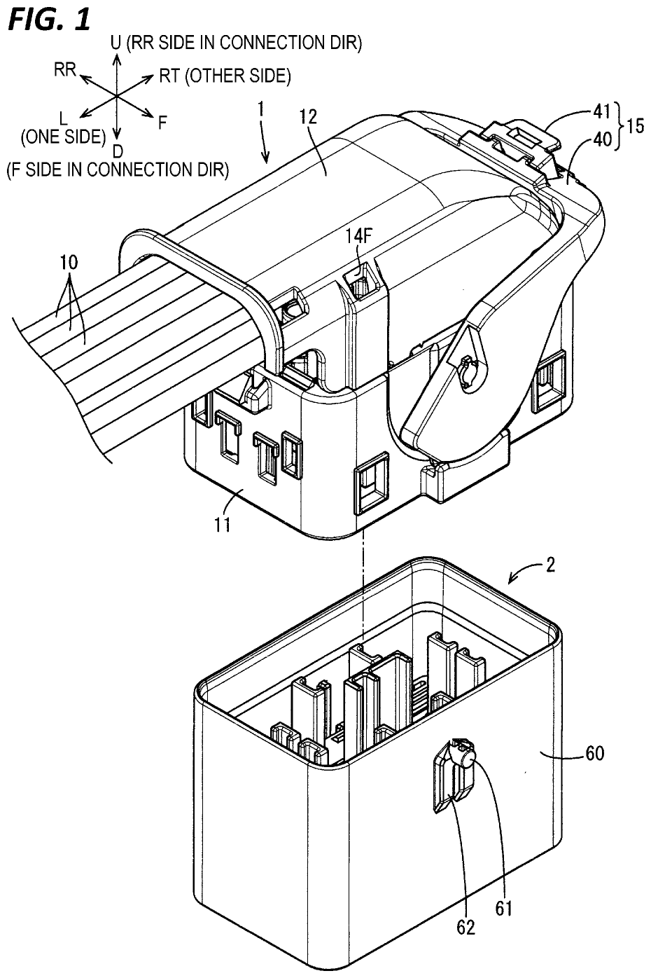

A first embodiment is described with reference to FIGS. 1 to 13. In the following description, a lateral direction, a front-rear direction and a vertical direction are based on a lateral direction, a front-rear direction and a vertical direction shown in FIG. 1. The vertical direction is an example of a connection direction, a lower side is an example of a front side in the connection direction and an upper side is an example of a rear side in the connection direction. The lateral direction is an example of a first direction orthogonal to the connection direction, a left side is an example of one side in the first direction and a right side is an example of the other side. The front-rear direction is an example of a second direction orthogonal to both the connection direction and the first direction.

In the following description, wires may not be shown in some cases. Further, in the following description, the same constituent elements, except some, may not be denoted by reference signs in figures.

### (1) Lever-Type Connector

A lever-type connector 1 (an example of a connector) according to the first embodiment is described with reference to FIG. 1. The lever-type connector 1 is a female connector to be connected to a male connector 2 (an example of a mating connector).

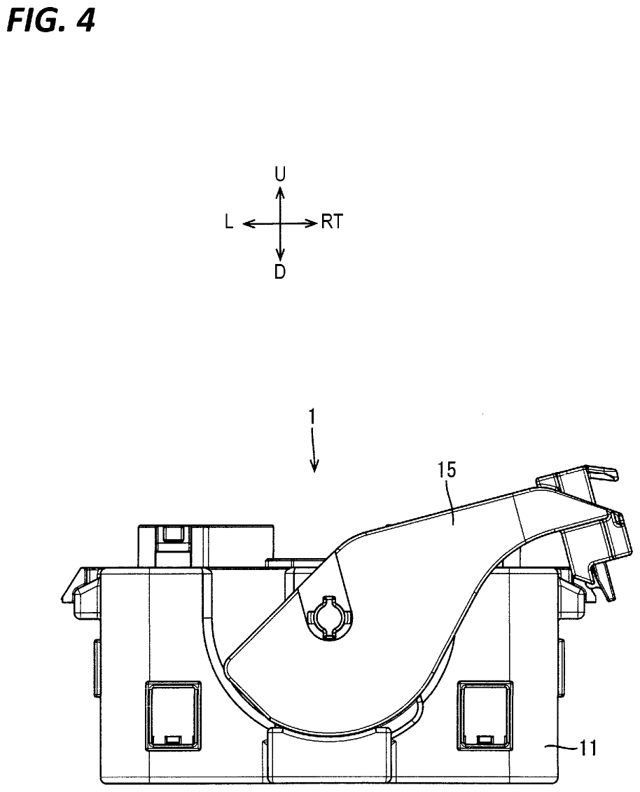

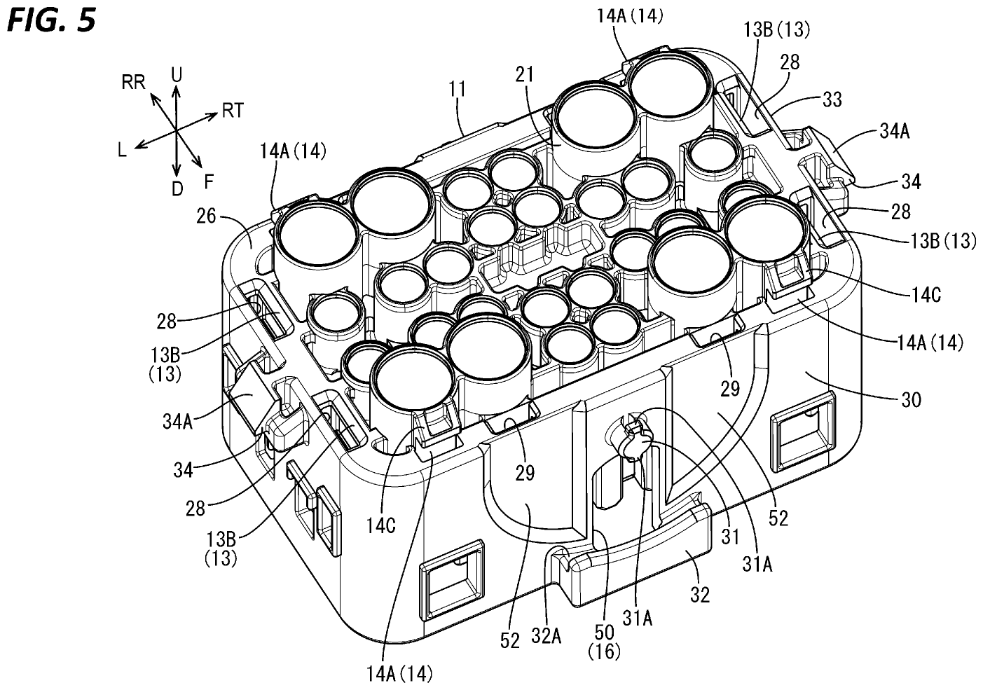

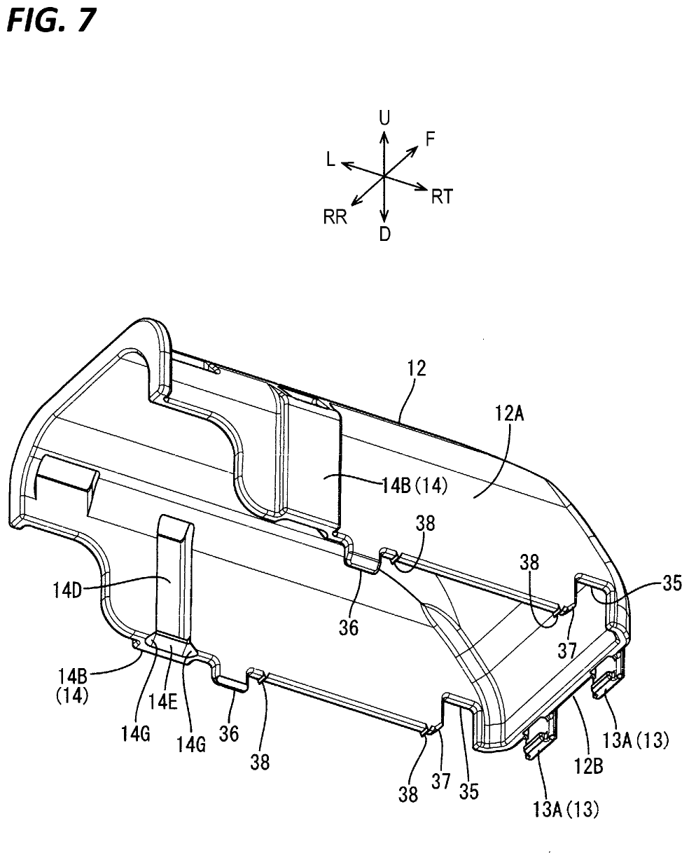

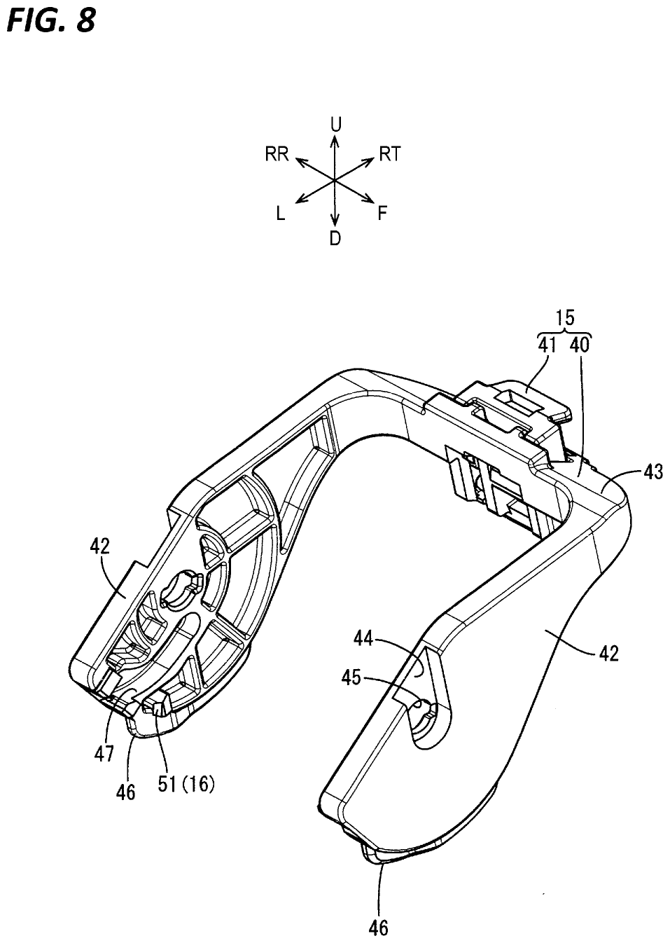

The lever-type connector 1 is provided with a connector body 11 made of synthetic resin and having wires 10 pulled out from an upper side (rear side in the connection direction), a wire cover 12 made of synthetic resin and disposed above the connector body 11, a first lock portion 13 (see FIGS. 5 and 7) for locking the connector body 11 and the wire cover 12, a second lock portion 14 (see FIGS. 5 and 7) for locking the connector body 11 and the wire cover 12, a lever 15 made of synthetic resin for assisting the connection and separation of the connector body 11 and the male connector 2 by a booster mechanism and a temporary locking portion 16 (see FIGS. 5 and 8) for temporarily locking the lever 15 at a transportation position (an example of a temporary locking position) shown in FIG. 4.

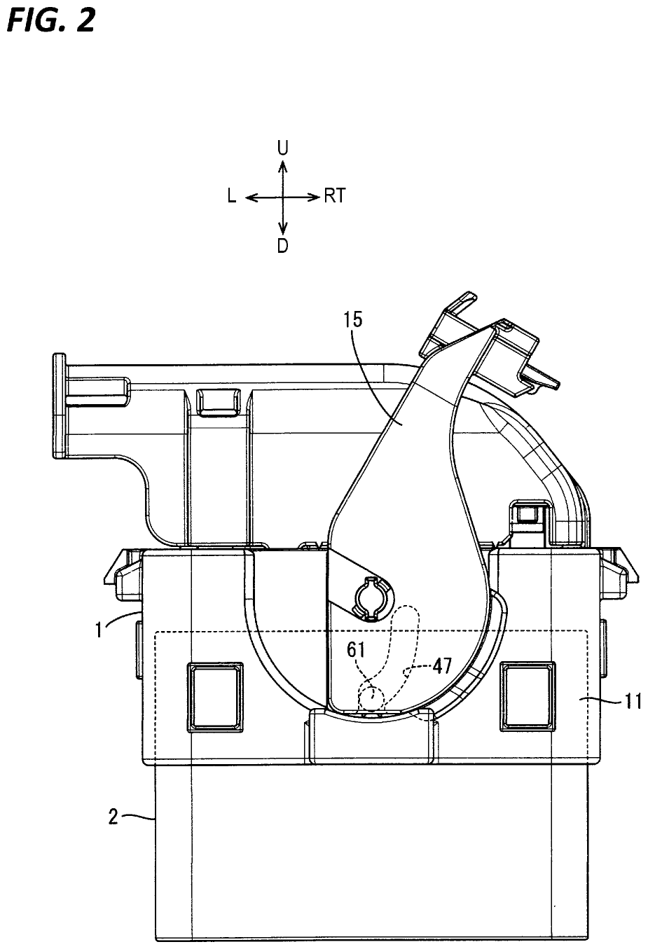

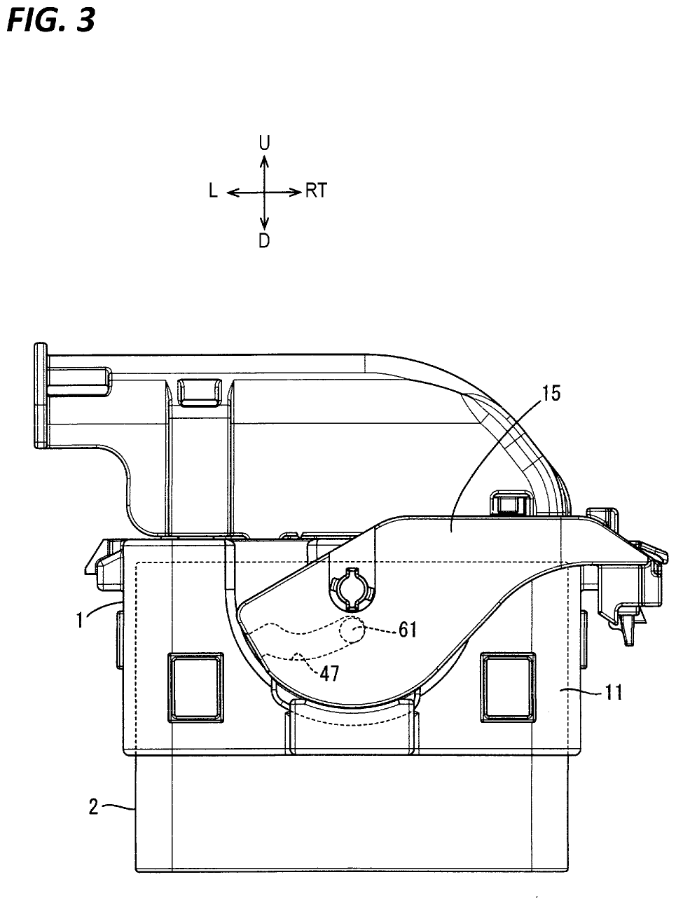

An initial connection position, a connection completion position and the transportation position of the lever 15 are described with reference to FIGS. 2, 3 and 4. The lever 15 is assembled with the connector body 11 rotatably from the initial connection position shown in FIG. 2 to the connection completion position shown in FIG. 3. The transportation position shown in FIG. 4 is a position between the initial connection position and the connection completion position. The transportation position is a position where the lever 15 is temporarily locked during transportation in the case of transporting the lever-type connector 1 produced in a factory to another factory and connecting the lever-type connector 1 to the male connector 2.

### (1-1) Connector Body

As shown in FIG. 5, the connector body 11 has a substantially rectangular parallelepiped shape. The connector body 11 is formed to be symmetrical in the front-rear direction and lateral direction. In the following description, if the shape of a right side of the connector body 11 is described, the shape of a left side is not described. This applies also to the front-rear direction.

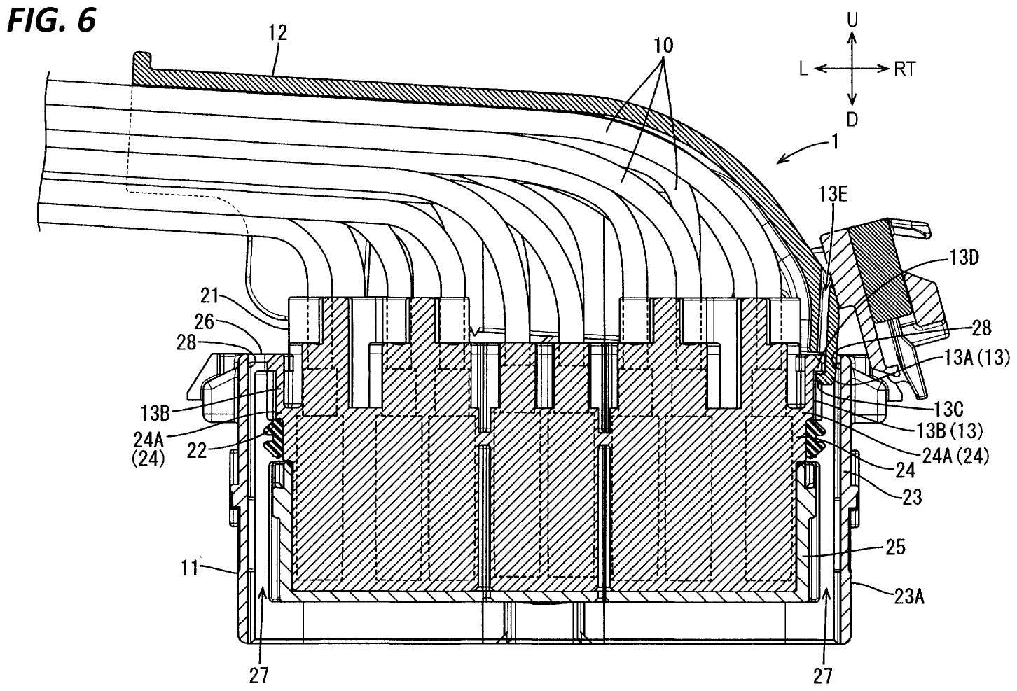

As shown in FIG. 6, the connector body 11 includes an outer housing 23, an inner housing 24 accommodated inside the outer housing 23, a sealing ring 22 made of synthetic resin and mounted on the outer peripheral surface of the inner housing 24 and a retainer 25 for retaining the sealing ring 22 from below.

The outer housing 23 has a rectangular shape when viewed from above, and upper and lower sides are open. The inner housing 24 has a rectangular shape smaller than the outer housing 23 when viewed from above. The inner housing 24 also has open upper and lower sides. A plurality of tubular terminal holding portions 21 are integrally formed inside the inner housing 24. Tubular metal terminals (female terminals) fixed to tip parts of the wires 10 are held inside the terminal holding portions 21.

An upper end part of the outer housing 23 and an upper end part of the inner housing 24 are coupled by a frame-like coupling wall 26 (see FIGS. 5 and 6). A space 27 into which a receptacle 60 (see FIG. 1) of the male connector 2 is fit and inserted is secured between the outer housing 23 and the inner housing 24.

The retainer 25 is open on an upper side and, on the other hand, formed with a bottom wall on a lower side. The retainer 25 is fit to the inner housing 24 from below to surround a lower end part of the inner housing 24 from outside. The bottom wall of the retainer 25 is formed with openings, through which male terminals of the male connector 2 are inserted.

As shown in FIG. 5, two openings 28 are formed in each of both left and right sides of the frame-like coupling wall 26. The two openings 28 on the left side are disposed apart from each other in the front-rear direction. The two openings 28 on the right side are also disposed apart from each other in the front-rear direction. First lock pieces 13A (see FIG. 7) of the wire cover 12 to be described later are inserted into these openings 28.

Two openings 29 are also formed in each of both front and rear sides of the frame-like coupling wall 26. Positioning pieces 36 (see FIG. 7) of the wire cover 12 to be described later are inserted into these openings 29.

A rotary shaft 31 for rotatably supporting the lever 15 is provided at a substantially lateral center on the outer surface (forward facing surface) of a front wall 30 of the outer housing 23. Projections 31A are formed on both upper and lower sides of a tip part of the rotary shaft 31. These projections 31A are for retaining the lever 15.

A guide portion 32, into which a guide rib 46 (see FIG. 8) formed on the lever 15 to be described later is fit, is formed below the rotary shaft 31 on the outer surface (forward facing surface) of the front wall 30 of the outer housing 23. A guide groove 32A is formed in the upper surface of the guide portion 32. The bottom surface of the guide groove 32A is formed into an arc shape centered on the rotary shaft 31. The opening of the lever 15 in the front-rear direction is suppressed by fitting the guide rib 46 into the guide groove 32A.

An engaging projection 34 for restricting the rotation of the lever 15 rotated to the connection completion position toward the initial connection position is integrally formed on the outer surface (rightward facing surface) of a right wall 23A of the outer housing 23. The engaging projection 34 has a slope 34A inclined rightward toward a lower side. If the lever 15 is rotated toward the connection completion position, the lever 15 rides over the slope 34A and is engaged with the engaging projection 34. In this way, the rotation of the lever 15 toward the initial connection position is restricted.

### (1-2) Wire Cover

As shown in FIG. 7, the wire cover 12 has a substantially box shape. The wire cover 12 is formed to be symmetrical in the front-rear direction. In the following description, if the shape of a front side of the wire cover 12 is described, the shape of a rear side is not described.

A left side (one side in the first direction) of the wire cover 12 is open. The wires 10 pulled out from the connector body 11 are bent leftward inside the wire cover 12 and pulled out from the wire cover 12.

A right upper corner part of the wire cover 12 is formed into a curved surface gently curved downward toward the right.

A second lock receiving portion 14B protruding forward and extending in the vertical direction is formed to the left of a lateral center on a front wall 12A of the wire cover 12. The second lock receiving portion 14B is described later.

The front wall 12A of the wire cover 12 is formed with a cut 35. Although described in detail later, the connector body 11 is provided with two second lock pieces 14A on each of both front and rear sides. The two second lock pieces 14A provided on the same side in the front-rear direction are separated on left and right sides with respect to a lateral center of the connector body 11. The cut 35 is for allowing a body-side second engaging projection 14C (see FIG. 5) of the second lock piece 14A on the right side to escape.

A corner part on the left side (one side), out of corner parts on a lower side (front side in the connection direction) of the cut 35, is chamfered to form a slope 37. The slope 37 is for suppressing the body-side second engaging projection 14C from contacting the corner part of the cut 35 to make rotation difficult when the wire cover 12 is rotated.

The positioning piece 36 extending downward is formed on a right side of the second lock receiving portion 14B on the front wall 12A. The positioning piece 36 is inserted into the opening 29 formed in the aforementioned coupling wall 26.

Two backlash eliminating ribs 38 are formed apart from each other in the lateral direction on a downward (forward in the connection direction) facing end surface of the front wall 12A of the wire cover 12. The backlash of the wire cover 12 and the connector body 11 is eliminated by the contact of these ribs 38 with the connector body 11.

### (1-3) First Lock Portion

The first lock portion 13 is composed of two first lock pieces 13A provided on the wire cover 12 as shown in FIG. 7 and four second lock receiving portions 13B provided on the connector body 11 as shown in FIG. 5. As shown in FIG. 6, the first lock portion 13 is provided on a right side (other side in the first direction) of the wires 10.

As shown in FIG. 7, the two first lock pieces 13A are disposed apart from each other in the front-rear direction. Both front and rear sides of an upper part of the first lock piece 13A are connected to a rearward facing surface of a right wall 12B of the wire cover 12, and the first lock piece 13A extends downward from the right wall 12B. A space is secured between a part excluding the both front and rear sides, out of the upper part of the first lock piece 13A, and the right wall 12B, thereby forming an opening 13E (see FIG. 6) when viewed from above.

As shown in FIG. 6, the first lock piece 13A is located on a right side (other side) of the first lock receiving portion 13B. The first lock piece 13A includes a cover-side first engaging projection 13C. The cover-side first engaging projection 13C protrudes leftward (toward the one side) from the first lock piece 13A and extends in the front-rear direction (direction perpendicular to the plane of FIG. 6).

As shown in FIG. 5, two first lock receiving portions 13B are provided on each of both sides in the lateral direction (first direction). The two first lock receiving portions 13B on the right side are respectively provided inside the two openings 28 formed in the right part of the frame-like coupling wall 26. The two first lock receiving portions 13B on the left side are respectively provided inside the two openings 28 formed in the left part of the frame-like coupling wall 26. When viewed from above (behind in the connection direction), the four first lock receiving portions 13B are disposed point-symmetrically with respect to a center point of the connector body 11.

As shown in FIG. 6, the first lock receiving portion 13B includes a body-side first engaging projection 13D protruding rightward (toward the other side in the first direction) from the right wall 24A of the inner housing 24 inside the opening 28. The body-side first engaging projection 13D protrudes rightward from the right wall 24A and extends in the front-rear direction (direction perpendicular to the plane of FIG. 6). The body-side first engaging projection 13D engages the cover-side first engaging projection 13C. In the first embodiment, it is assumed that the right wall 24A of the inner housing 24 is also a part of the first lock receiving portion 13B.

The connector body 11 is provided with a wall for suppressing the disengagement of the cover-side first engaging projections 13C from the body-side first engaging projections 13D at a position on the right side (other side in the first direction) of the first lock pieces 13A. In the first embodiment, the right wall 23A of the outer housing 23 doubles as this wall (wall for suppressing the disengagement of the cover-side first engaging projections 13C from the body-side first engaging projections 13D).

### (1-4) Second Lock Portion

The second lock portion 14 is composed of four second lock pieces 14A extending upward (rearward in the connection direction) from the connector body 11 as shown in FIG. 5 and two second lock receiving portions 14B provided on the wire cover 12 as shown in FIG. 7.

As shown in FIG. 5, two second lock pieces 14A are provided on each of both sides in the front-rear direction of the connector body 11. The two second lock pieces 14A provided on the same side in the front-rear direction are provided on a left side (one side) and a right side (other side) with respect to a center in the lateral direction (first direction) of the connector body 11. When viewed from above (behind in the connection direction), the four second lock pieces 14A are disposed point-symmetrically with respect to the center point of the connector body 11.

In the first embodiment, the second lock pieces 14A are integrated with the tubular terminal holding portions 21. The second lock piece 14A includes the body-side second engaging projection 14C. The body-side second engaging projection 14C of the second lock piece 14A on the front side protrudes forward from an upper end part of the second lock piece 14A and extends in the lateral direction. The body-side second engaging projection 14C is chamfered on an upper front corner part to form a slope.

The second lock receiving portions 14B provided on the wire cover 12 are described with reference to FIG. 7. The second lock receiving portion 14B is formed at a position corresponding to the left second lock piece 14A. A groove 14D extending in the vertical direction is formed in the inner surface of the second lock receiving portion 14b.

As shown in FIG. 1, a through hole 14F is formed to extend the groove 14D upward on an upper end part of the second lock receiving portion 14B. As shown in FIG. 7, a cover-side second engaging projection 14E to be engaged with the body-side second engaging projection 14C of the connector body 11 is integrally formed in a lower end part of the groove 14D. The cover-side second engaging projection 14E protrudes inward from the inner surface of the groove 14D and extends in the lateral direction. The cover-side second engaging projection 14E is chamfered on an inner lower corner part to form a slope.

A corner on a lower side (rear side in the connection direction) and an inner side of the groove 14D is chamfered to form slopes 14G. The slopes 14G are for suppressing the body-side second engaging projection 14C from contacting the corner of the groove 14D to make rotation different when the wire cover 12 is rotated.

As described above, the four first lock receiving portions 13B provided on the connector body 11 are disposed point-symmetrically. The four second lock pieces 14A are also disposed point-symmetrically. Thus, a worker can mount the wire cover 12 such that the wires 10 are pulled out from the left side, and also can rotate the wire cover 12 by 180° and mount the wire cover 12 such that the wires 10 are pulled out from the right side. That is, the wire cover 12 can be reversibly mounted.

### (1-5) Lever

As shown in FIG. 1, the lever 15 is composed of a lever body 40 and a connection detecting member 41 assembled with the lever body 40.

As shown in FIG. 8, the lever body 40 is formed to be symmetrical in the front-rear direction. The lever body 40 includes two leg portions 42 and a coupling portion 43 coupling those two leg portions 42 on one end side.

A recess 44 recessed rearward from a front side is formed in a tip part of the front leg portion 42. The recess 44 is formed with a bearing hole 45 for bearing the rotary shaft 31. A lower part of the tip part of the leg portion 42 is formed into an arc shape centered on the bearing hole 45. The arcuate guide rib 46 to be fit into the guide groove 32A of the connector body 11 is formed on the end surface of the arcuate lower part.

Cam grooves 47, into which cam pins 61 projecting from the outer surface of the male connector 2 are to be inserted, are formed inside the lever 15. When the lever 15 is at the initial connection position, the cam grooves 47 are in such a posture that entrances are facing down.

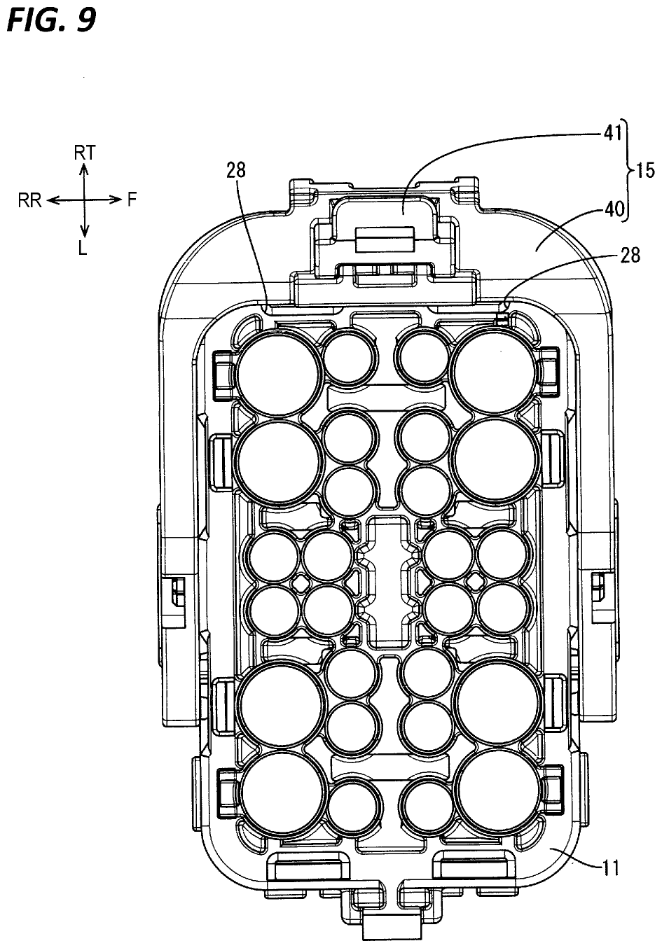

As shown in FIG. 9, when the lever 15 is temporarily locked at the transportation position, at least parts of the openings 28 (examples of positions of the connector body 11 where the first lock pieces 13A are to be inserted) of the connector body 11 are not seen by being hidden behind the lever 15 when viewed from behind in the connection direction.

The connection detecting member 41 is described with reference to FIG. 1. The connection detecting member 41 is assembled with the lever 15 movably from a standby position (position shown in FIG. 1) to a detection position (not shown) with respect to the lever 15. The connection detecting member 41 is for enabling the worker to confirm the connection completion of the lever-type connector 1 and the male connector 2 and can be pushed toward the detection position when the lever 15 is rotated to the connection completion position.

### (1-6) Temporary Locking Portion

The temporary locking portion 16 for temporarily locking the lever 15 at the transportation position is described with reference to FIGS. 5 and 8. As shown in FIG. 5, a cut 50 recessed upward from the lower end surface of the front wall 30 is formed below the rotary shaft 31 in the front wall 30 of the outer housing 23. On the other hand, as shown in FIG. 8, a locking projection 51 protruding inward is formed on an inner side of the leg portion 42 of the lever 15. The cut 50 of the front wall 30 and the locking projection 51 of the lever 15 constitute the temporary locking portion 16.

Recesses 52 for allowing the locking projection 51 of the lever 15 to escape are formed on both left and right sides of the cut 50 in the front surface (forward facing surface) of the front wall 30 of the outer housing 23. When the lever 15 is at the initial connection position, the locking projection 51 is at a position overlapping the right recess 52 when viewed from front. If the lever 15 is rotated toward the connection completion position, the locking projection 51 is fit into the cut 50 after riding over a vertically long part between the right recess 52 and the cut 50. In this way, the lever 15 is temporarily locked at the transportation position.

When the locking projection 51 is fit in the cut 50 (i.e. when the lever 15 is at the transportation position), the worker can return the lever 15 to the initial connection position by rotating the lever 15 toward the initial connection position. In contrast, the locking projection 51 cannot ride over a vertically long part between the left recess 52 and the cut 50. Thus, the rotation of the lever 15 temporarily locked at the transportation position toward the connection completion position is restricted.

Here, as described above, the opening of the lever 15 in the front-rear direction is suppressed by fitting the guide ribs 46 into the guide grooves 32A. Thus, when the lever 15 is at the transportation position (i.e. when the locking projection 51 is fit in the cut 50), the lever 15 is suppressed from being opened in the front-rear direction to disengage the locking projection 51 from the cut 50. In this way, the rotation of the lever 15 temporarily locked at the transportation position toward the connection completion position can be more reliably restricted.

### (1-7) Mounting Procedure of Wire Cover on Connector Body

A mounting procedure of the wire cover 12 on the connector body 11 is described with reference to FIGS. 6 and 9 to 13.

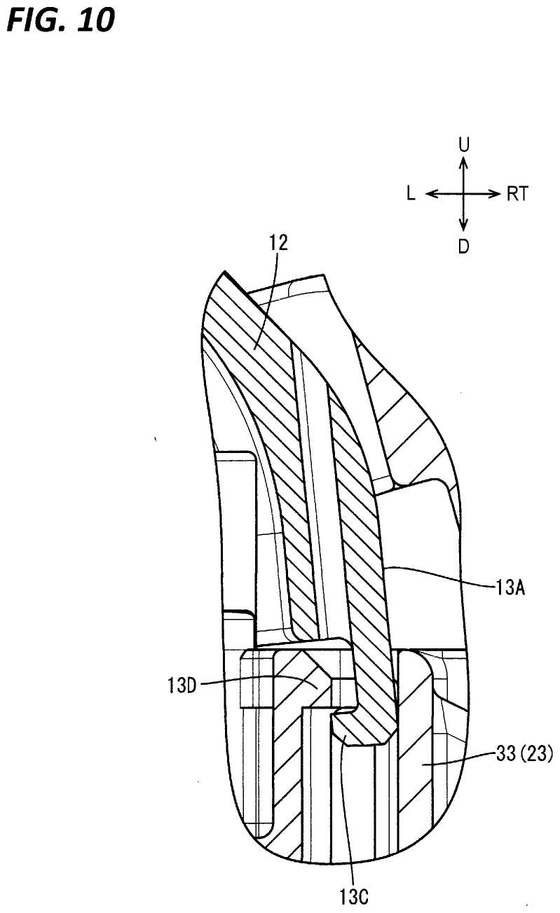

Step 1: As shown in FIG. 9 described above, when the lever 15 is temporarily locked at the transportation position, parts of the openings 28 of the connector body 11 are not seen by being hidden behind the lever 15 when viewed from behind in the connection direction. Thus, as shown in FIG. 10, the worker engages the cover-side first engaging projections 13C with the body-side first engaging projections 13D by obliquely inserting the first lock pieces 13A of the wire cover 12 toward a right lower side and pushing down the first lock pieces 13A while resiliently deforming the first lock pieces 13A. In this way, a state shown in FIG. 6 is attained. In the state shown in FIG. 6, the wire cover 12 is inclined to a left upper side and the second lock portion 14 is not locked yet.
Step 2: In the state shown in FIG. 6, the worker rotates the wire cover 12 counterclockwise (in a direction to lock the second lock portion 14) with contact points of the cover-side first engaging projections 13C and the body-side first engaging projections 13D as fulcrums. At this time, the wires 10 are bent leftward by the wire cover 12. That is, the worker rotates the wire cover 12 while bending the wires 10.

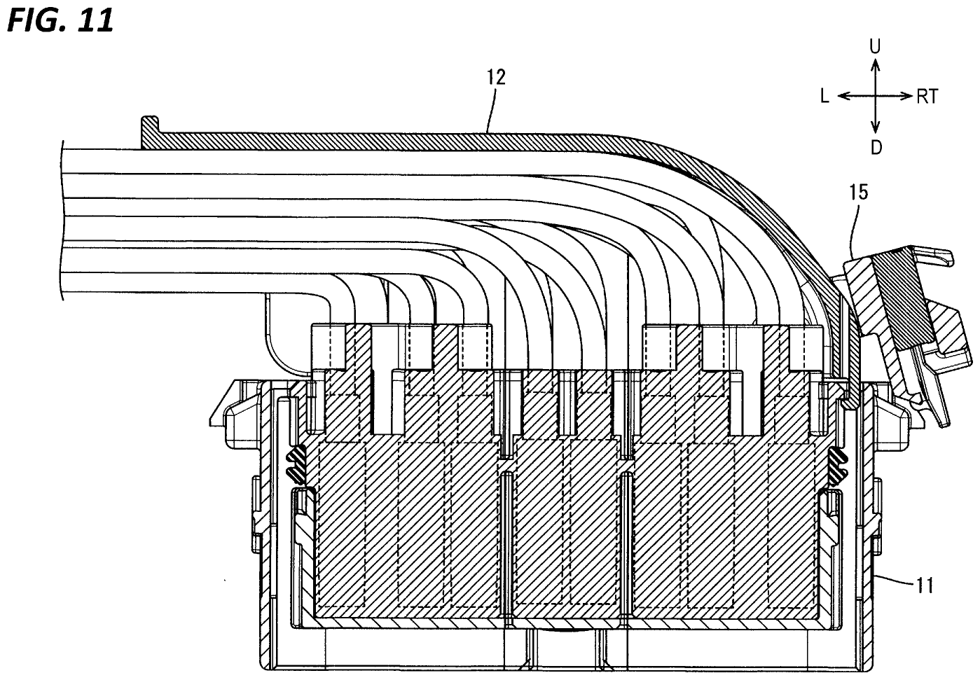

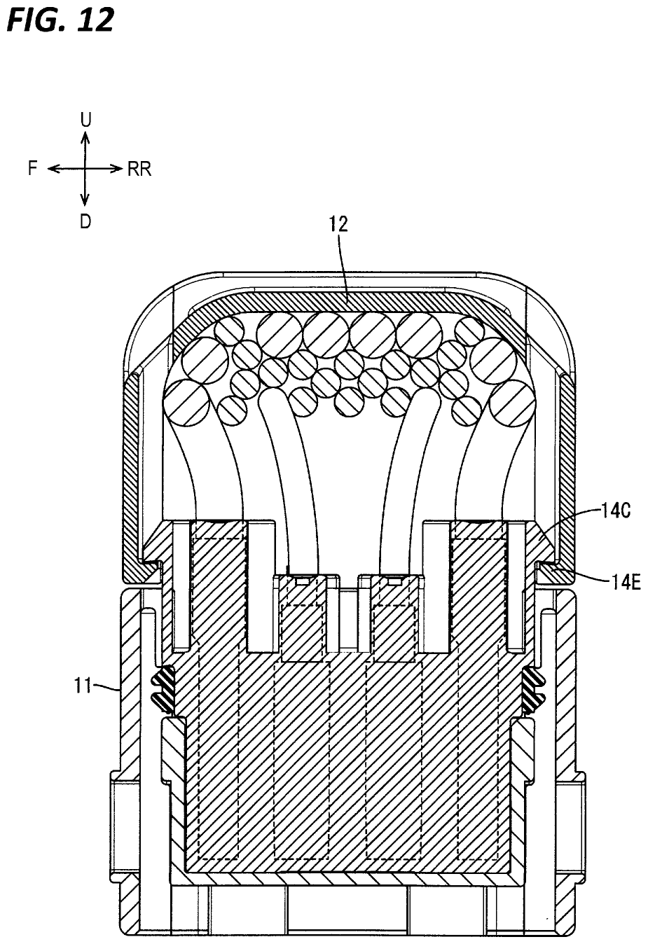

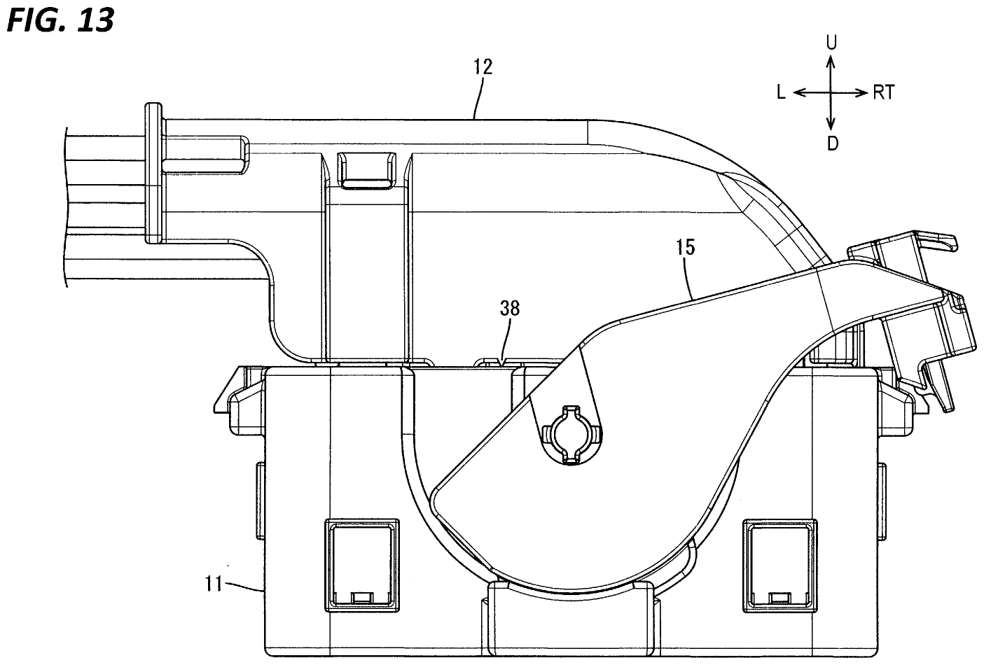

Here, as shown in FIG. 10, when the wire cover 12 is rotated counterclockwise, there is a possibility that the cover-side first engaging projections 13C are disengaged rightward (toward the other side in the first direction) from the body-side first engaging projections 13D. However, since the wall (i.e. the right wall 23A of the outer housing 23) for suppressing the rightward disengagement of the cover-side first engaging projections 13C from the body-side first engaging projections 13D is provided on the right side of the first lock pieces 13A, the cover-side first engaging projections 13C are made less likely to be disengaged from the body-side first engaging projections 13D by the contact of the first lock pieces 13A with the right wall 23A.
Step 3: As shown in FIG. 11, if the wire cover 12 is rotated to the left side, the cover-side second locking projections 14E are engaged with the body-side second engaging projections 14C as shown in FIG. 12, whereby the second lock portion 14 is locked. In this way, the wire cover 12 is mounted on the connector body 11 as shown in FIG. 13.

If the wire cover 12 is mounted on the connector body 11, the backlash eliminating ribs 38 of the wire cover 12 come into contact with the connector body 11 to eliminate the backlash of the wire cover 12 and the connector body 11. Due to the presence of the backlash eliminating ribs 38, a gap is formed between the wire cover 12 and the connector body 11.

### (2) Male Connector

As shown in FIG. 1, the male connector 2 (an example of a mating connector) includes the tubular receptacle 60. The male terminals to be connected to the metal terminals (female terminals) of the lever-type connector 1 are held in the male connector 2. The cam pins 61 to be fit into the cam grooves 47 provided in the leg portions 42 of the lever 15 are formed on the outer surface of the receptacle 60.

A base portion 62 protruding forward is integrally formed on the outer surface of the receptacle 60. As shown in FIG. 2, when the lever-type connector 1 is connected to the male connector 2, the lever 15 is rotated from the transportation position to the initial connection position and, in that state, the lever-type connector 1 is lightly fit to the male connector 2. If the lever-type connector 1 is lightly fit to the male connector 2, the base portion 62 is inserted into the cut 50 of the outer housing 23 from below to close the cut 50. Since the locking projection 51 is not fit into the cut 50 if the cut 50 is closed, the lever 15 can be rotated to the connection completion position.

### (3) Connection of Lever-Type Connector and Male Connector

If the lever 15 is rotated from the initial connection position toward the connection completion position with the lever-type connector 1 lightly fit to the male connector 2 as shown in FIG. 2, the lever-type connector 1 is relatively pulled toward the male connector 2 by the cam action of the cam pins 61 and the cam grooves 47 caused by a rotating operation of the lever 15 as shown in FIG. 3. In this way, the lever-type connector 1 and the male connector 2 are connected.

The worker pushes the connection detecting member 41 toward the detection position after rotating the lever 15 to the connection completion position. In this way, the connection detecting member 41 moves to the detection position and the connection is detected.

### (4) Effects of Embodiment

According to the lever-type connector 1 of the first embodiment, the worker can lock the second lock portion 14 while bending the wires 10 leftward (toward the one side in the first direction) by the wire cover 12 by rotating the wire cover 12 leftward (in the direction to lock the second lock portion 14) with the contact points of the cover-side first engaging projections 13C and the body-side first engaging projections 13D as fulcrums when mounting the wire cover 12 on the connector body 11. That is, according to the lever-type connector 1, the work efficiency of the worker is improved since an operation of bending the wires 10 and an operation of locking the second lock portion 14 can be performed as one operation.

Further, according to the lever-type connector 1, since the wall (right wall 23A of the outer housing 23) for suppressing the rightward (toward the other side) disengagement of the cover-side first engaging projections 13C from the body-side first engaging projections 13D is provided on the right side (other side in the first direction) of the first lock pieces 13A, the cover-side first engaging projections 13C are made less likely to be disengaged from the body-side first engaging projections 13D by the contact of the first lock pieces 13A with the right wall 23A. Thus, according to the lever-type connector 1, the wire covers 12 can be stably mounted even in the case of using the wires 10 having a large diameter.

According to the lever-type connector 1, when the lever 15 is temporarily locked at the transportation position, the worker can intuitively understand that the first lock pieces 13A need to be obliquely inserted into the connector body 11 since at least parts of the positions (openings 28) where the first lock pieces 13A are to be inserted are not seen by being hidden behind the lever 15. In other words, the worker can intuitively understand a method of mounting the wire cover 12 by obliquely inserting the first lock pieces 13A into the connector body 11.

According to the lever-type connector 1, since the four first lock receiving portions 13B are disposed point-symmetrically with respect to the center point of the connector body 11 and the four second lock pieces 14A are disposed point-symmetrically with respect to the center point in the connector body 11 when viewed from above (behind in the connection direction), the wire cover 12 can be mounted on the connector body 11 even if being rotated by 180° about the center point of the connector body 11 when viewed from above. Thus, the wires 10 can be selectively pulled out from the left side and the right side, using one type of connector. In other words, the wire cover 12 can be reversibly used. Therefore, production cost and management cost can be suppressed as compared to the case where two types of connectors are prepared.

According to the lever-type connector 1, since the left corner part, out of the corner parts on the lower side (front side in the connection direction) of the cut 35, is chamfered to form the slope 37, it can be suppressed that the wire cover 12 becomes hard to rotate due to the contact of the body-side second engaging projection 14C with the corner part of the cut 35.

According to the lever-type connector 1, since the corner on the lower side (front side in the connection direction) and the inner side of the groove 14D is chamfered to form the slopes 14G, it can be suppressed that the wire cover 12 becomes hard to rotate due to the contact of the body-side second engaging projection 14C with the corner of the groove 14D.

According to the lever-type connector 1, the backlash of the wire cover 12 and the connector body 11 can be eliminated by the backlash eliminating ribs 38. Further, since the gap is formed between the wire cover 12 and the connector body 11 due to the presence of the backlash eliminating ribs 38, the wire cover 12 mounted on the connector body 11 can be removed by inserting a jig into this gap.

### Second Embodiment

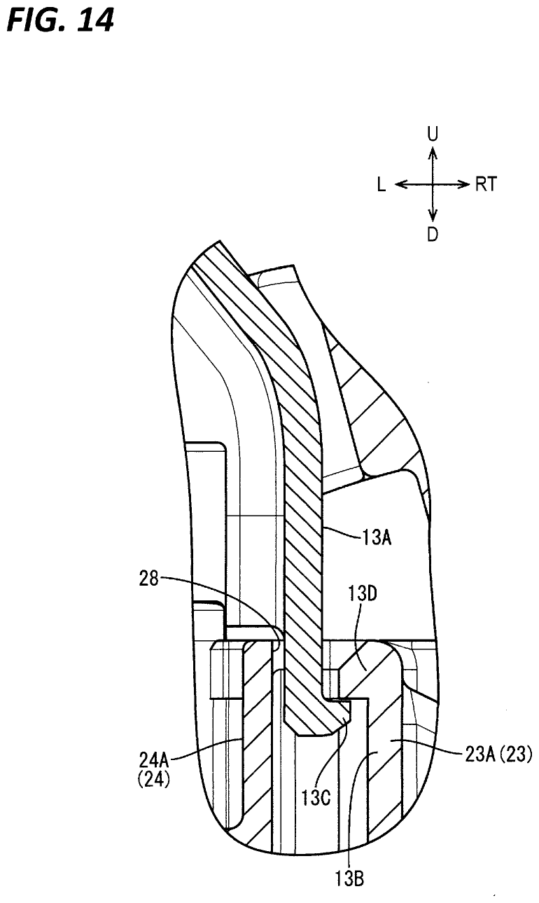

A lever-type connector according to a second embodiment is described with reference to FIG. 14.

A first lock piece 13A according to the second embodiment is located on a left side (one side in the first direction) of a first lock receiving portion 13B and a cover-side first engaging projection 13C protrudes rightward (toward the other side) from the first lock piece 13A.

The first lock receiving portion 13B includes a body-side first engaging projection 13D protruding leftward (toward the one side in the first direction) from a right wall 23A of an outer housing 23 inside an opening 28. In the second embodiment, the right wall 23A of the outer housing 23 is assumed to be also a part of the first lock receiving portion 13B.

According to a lever-type connector 1 of the second embodiment, a wall (a right wall 24A of an inner housing 24) for suppressing leftward disengagement of the cover-side first engaging projections 13C from the body-side first engaging projections 13D is provided on a left side (one side in the first direction) of the first lock pieces 13A. Thus, the cover-side first engaging projections 13C are made less likely to be disengaged from the body-side first engaging projections 13D by the contact of the first lock pieces 13A with the right wall 24A. Thus, a wire cover 12 can be stably mounted even in the case of using wires 10 having a large diameter.

### Other Embodiment

The technique disclosed by this specification is not limited to the above described and illustrated embodiments. For example, the following embodiments are also included in a technical scope disclosed by this specification.
(1) In the above first embodiment, the second lock pieces 14A of the second lock portion 14 are provided on the connector body 11 and the second lock receiving portions 14B are provided on the wire cover 12. In contrast, the second lock pieces 14A may be provided on the wire cover 12 and the second lock receiving portions 14B may be provided on the connector body 11. The connector body 11 may be provided with the cuts 35 and left corner parts, out of corner parts on the upper side (rear side in the connection direction) of the cuts 35 may be chamfered. The corner on the upper side (rear side in the connection direction) and the inner side of the groove 14D may be chamfered.

According to such a lever-type connector, four first lock receiving portions 13B are disposed point-symmetrically with respect to the center point of the connector body 11 and four second lock receiving portions 14B are disposed point-symmetrically with respect to the center point in the connector body 11 when viewed from above (behind in the connection direction). Thus, even if the wire cover 12 is rotated by 180° about the center point of the connector body 11 when viewed from the above (behind in the connection direction), the wire cover 12 can be mounted on the connector body 11. Thus, the wires 10 can be selectively pulled out from one side and the other side in the first direction, using one type of connector. In other words, the wire cover 12 can be reversibly used. Therefore, production cost and management cost can be suppressed as compared to the case where two types of connectors are prepared.

According to such a lever-type connector, since the left corner part, out of the corner parts on the upper side (rear side in the connection direction) of the cut 35 provided in the connector body 11, is chamfered, it can be suppressed that the wire cover 12 is made hard to rotate by the contact of the cover-side second engaging projection 14E with the corner part of the cut 35.

According to such a lever-type connector, since the corner on the upper side (rear side in the connection direction) and the inner side of the groove 14D is chamfered, it can be suppressed that the wire cover 12 is made hard to rotate by the contact of the cover-side second engaging projection 14E with the corner of the groove 14D.
(2) Although the lever-type connector 1 has been illustrated as the connector in the above embodiments, the connector may not include the lever 15.
(3) In the above embodiments, when the lever 15 is temporarily locked at the transportation position, parts of the positions (openings 28) of the connector body 11 where the first lock pieces 13A are to be inserted are not seen by being hidden behind the lever 15 when viewed from above (behind in the connection direction). In contrast, the entire positions (openings 28) where the first lock pieces 13A are to be inserted may be seen from above.
(4) Although the wire cover 12 can be reversibly mounted in the above first embodiment, the wire cover 12 may be configured not to be reversibly mounted.
(5) Although the left (one side) corner part, out of the corner parts on the lower side (front side in the connection direction) of the cut 35, is chamfered to form the slope 37 in the above first embodiment, the slope 37 may not be formed.
(6) Although the cover-side second engaging projection 14E is provided inside the groove 14D and the corner on the lower side (front side in the connection direction) and the inner side of the groove 14D is chamfered to form the slopes 14G in the above first embodiment, the slopes 14G may not be formed.
(7) Although the backlash eliminating ribs 38 are formed on the downward (forward) facing end surface of the wire cover 12 in the above first embodiment, the backlash eliminating ribs 38 may not be formed. Alternatively, the backlash eliminating ribs 38 may be formed on a surface facing this end surface in the connector body 11.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector to be connected to a mating connector, comprising:
a connector body, a wire being pulled out from a rear side in a connection direction;
a box-shaped wire cover disposed on the rear side in the connection direction of the connector body, one side of the wire cover in a first direction orthogonal to the connection direction being open, the wire pulled out from the connector body being bent toward the one side inside the wire cover and pulled out from the wire cover;
a first lock portion for locking the connector body and the wire cover, the first lock portion being provided further on the other side in the first direction than the wire; and
second lock portions for locking the connector body and the wire cover, the second lock portion being provided on each of both sides in a second direction orthogonal to both the connection direction and the first direction,
the first lock portion including:
a first lock piece extending forward in the connection direction from the wire cover, the first lock piece including a cover-side first engaging projection protruding toward the one side; and
a first lock receiving portion provided further on the one side than the first lock piece in the connector body, the first lock receiving portion including a body-side first engaging projection protruding toward the other side and to be engaged with the cover-side first engaging projection, and
a wall for suppressing the cover-side first engaging projection from being disengaged from the body-side first engaging projection being provided further on the other side than the first lock piece.

2. A connector to be connected to a mating connector, comprising:
a connector body, a wire being pulled out from a rear side in a connection direction;
a box-shaped wire cover disposed on the rear side in the connection direction of the connector body, one side of the wire cover in a first direction orthogonal to the connection direction being open, the wire pulled out from the connector body being bent toward the one side inside the wire cover and pulled out from the wire cover;
a first lock portion for locking the connector body and the wire cover, the first lock portion being provided further on the other side in the first direction than the wire; and
second lock portions for locking the connector body and the wire cover, the second lock portion being provided on each of both sides in a second direction orthogonal to both the connection direction and the first direction,
the first lock portion including:
a first lock piece extending forward in the connection direction from the wire cover, the first lock piece including a cover-side first engaging projection protruding toward the other side; and
a first lock receiving portion provided further on the other side than the first lock piece in the connector body, the first lock receiving portion including a body-side first engaging projection protruding toward the one side and to be engaged with the cover-side first engaging projection, and
a wall for suppressing the cover-side first engaging projection from being disengaged from the body-side first engaging projection being provided further on the one side than the first lock piece.

3. The connector of claim 1, comprising:
a lever assembled with the connector body rotatably from an initial connection position to a connection completion position, the lever assisting connection of the connector body and the mating connector by a booster mechanism; and
a temporary locking portion for temporarily locking the lever at a temporary locking position between the initial connection position and the connection completion position,
wherein, when the lever is temporarily locked at the temporary locking position, at least a part of a position where the first lock piece is to be inserted in the connector body is not seen by being hidden behind the lever when viewed from behind in the connection direction.

4. The connector of claim 1, wherein:
the second lock portion includes:
a second lock piece extending rearward in the connection direction from the connector body, the second lock piece including a body-side second engaging projection; and
a second lock receiving portion provided on the wire cover, the second lock receiving portion including a cover-side second engaging projection to be engaged with the body-side second engaging projection, and
the connector body is provided with the first lock receiving portion on each of both sides in the first direction and the second lock piece on each of both sides in the second direction, and a plurality of the first lock receiving portions are disposed point-symmetrically with respect to a center point of the connector body and a plurality of the second lock pieces are disposed point-symmetrically with respect to the center point when viewed from behind in the connection direction.

5. The connector of claim 4, wherein:
the connector body is provided with two second lock pieces on each of the both sides in the second direction and the two second lock pieces provided on the same side in the second direction are provided on the one side and the other side with respect to a center in the first direction of the connector body,
the wire cover is provided with the second lock receiving portions at positions corresponding to the second lock pieces on the one side and formed with cuts for allowing the body-side second engaging projections to escape at positions corresponding to the second lock pieces on the other side, and
a corner part on the one side, out of corner parts on a front side in the connection direction of the cut, is chamfered to form a slope.

6. The connector of claim 5, wherein:
the second lock receiving portion includes a groove formed in an inner surface of the wire cover and extending in the connection direction, the body-side second engaging projection being inserted into the groove from front in the connection direction,
the cover-side second engaging projection is provided in the groove, and
a corner on a front side in the connection direction and an inner side of the groove is chamfered to form a slope.

7. The connector of claim 1, wherein:
the second lock portion includes:
a second lock piece extending forward in the connection direction from the wire cover, the second lock piece including a cover-side second engaging projection; and
a second lock receiving portion provided on the connector body, the second lock receiving portion including a body-side second engaging projection to be engaged with the cover-side second engaging projection, and
the connector body is provided with the first lock receiving portion on each of both sides in the first direction and the second lock receiving portion on each of both sides in the second direction, and a plurality of the first lock receiving portions are disposed point-symmetrically with respect to a center point of the connector body and a plurality of the second lock receiving portions are disposed point-symmetrically with respect to the center point when viewed from behind in the connection direction.

8. The connector of claim 7, wherein:
the wire cover is provided with two second lock pieces on each of both sides in the second direction and the two second lock pieces provided on the same side in the second direction are provided on the one side and the other side with respect to a center in the first direction of the connector body,
the connector body is provided with the second lock receiving portions at positions corresponding to the second lock pieces on the one side and formed with cuts for allowing the cover-side second engaging projections to escape at positions corresponding to the second lock pieces on the other side, and
a corner part on the one side, out of corner parts on a rear side in the connection direction of the cut is chamfered to form a slope.

9. The connector of claim 8, wherein:
the second lock receiving portion includes a groove formed in an inner surface of the connector body and extending in the connection direction, the cover-side second engaging projection being inserted into the groove from behind in the connection direction,
the body-side second engaging projection is provided in the groove, and
a corner on a rear side in the connection direction and an inner side of the groove is chamfered to form a slope.

10. The connector of claim 1, wherein a backlash eliminating rib is formed on at least one of an end surface of the wire cover facing forward in the connection direction and a surface of the connector body facing the end surface.
